(19) United States
(12) Patent Application Publication
(10) Pub. No.: US 2021/0383628 A1
(43) Pub. Date: Dec. 9, 2021

(54) SPACE MANAGEMENT DEVICE

(71) Applicant: LIXIL Corporation, Tokyo (JP)

(72) Inventors: Susumu ISHIDA, Tokyo (JP); Hiroaki KIKUHARA, Tokyo (JP); Tomoko HASEGAWA, Tokyo (JP); Masaki YAMAZAKI, Tokyo (JP); Yasunobu MASU, Tokyo (JP); Katsuo ONO, Tokyo (JP); Mikihiro OIDA, Tokyo (JP); Masahiro MOTOMURA, Tokyo (JP)

(73) Assignee: LIXIL Corporation, Tokyo (JP)

(21) Appl. No.: 16/894,741

(22) Filed: Jun. 5, 2020

(51) Int. Cl. G07C 9/22; G07C 9/00; H04W 4/021; H04W 4/029; H04W 4/33

(52) U.S. Cl. CPC G07C 9/22; G07C 9/00182; G07C 2009/00277; H04W 4/029; H04W 4/33; H04W 4/021

(57) ABSTRACT

A space management device includes: a space information retaining unit that retains information regarding a living space including a building or premises where a person lives, lodges, or stays; a condition retaining unit that retains a condition regarding a position of a person or a movable body in the living space; a position information acquirer that acquires, from a detection device for detecting identification information and position information of a person or a movable body present in the living space, the identification information and position information; and a determination unit that refers to a condition retained in the condition retaining unit to determine whether or not a person or a movable body present in the living space is allowed to stay at the position or move to another position, based on the identification information and position information acquired by the position information acquirer.

### FIELD OF THE DISCLOSURE

The present disclosure relates to a space management technology, and more particularly, to a space management device that manages a space where a person or a movable body is present.

### BACKGROUND OF THE DISCLOSURE

Houses are important bases for people's lives. To secure safe and comfortable lives, various technologies for improving housing security are provided (see Patent Document 1, for example).

Patent Document 1 (Japanese Unexamined Patent Application Publication No. 2002-329277) discloses a room entrance/exit monitoring system that uses a mobile information terminal carried by a user and that detects a human being, an animal, or an artifact passing through a room or a building while carrying a mobile information terminal, and transmits the result to the mobile information terminal of the user.

For conventional houses, security technologies for isolating the lives within the houses from outside society have been considered important to protect safety and privacy of the residents. However, for future houses, a function to coordinate the lives within the houses and outside society will be required to realize enriched lives with improved convenience. For example, situations can be considered in which a service provider who provides a service, such as housekeeping, caregiving, and delivery, to a resident enters the resident's house to provide the service, or a service receiver who enjoys a service, such as private lodging and parking space rental, from a resident enters the resident's house to enjoy the service.

Realizing such new styles of houses requires a technology for appropriately managing a living space where a person other than residents or a movable body could be present.

### SUMMARY OF THE DISCLOSURE

The present disclosure has been made in view of such a problem, and a purpose thereof is to provide a technology for appropriately managing a space.

To solve the problem above, a space management device according to one aspect of the present disclosure includes; a space information retaining unit that retains information regarding a living space including a building or premises where a person lives, lodges, or stays; a condition retaining unit that retains a condition regarding a position of a person or a movable body in the living space; a position information acquirer that acquires, from a detection device for detecting identification information and position information of a person or a movable body present in the living space, the identification information and position information; and a determination unit that refers to a condition retained in the condition retaining unit to determine whether or not a person or a movable body present in the living space is allowed to stay at the position or move to another position, based on the identification information and position information acquired by the position information acquirer. The space information retaining unit retains information regarding multiple divided areas in the living space. The condition retaining unit retains a condition regarding staying in the area, entering the area, passing through the area, and exiting from the area, with respect to each area. The determination unit determines whether or not a person or a movable body identified by identification information acquired by the position information acquirer is allowed to stay in the area, enter the area, pass through the area, and exit from the area.

Optional combinations of the aforementioned constituting elements, and implementation of the present disclosure in the form of methods, apparatuses, systems, recording media, and computer programs may also be practiced as additional modes of the present disclosure.

### BRIEF DESCRIPTION OF THE FIGURES

Some embodiments will now be described, by way of example only, with reference to the accompanying drawings which are meant to be exemplary, not limiting, and wherein like elements are numbered alike in several Figures, in which:

FIG. 1 is a diagram that shows a configuration of a space management system, according to some embodiments;

FIG. 2 is a diagram that shows a configuration of a space management device, according to some embodiments; and

FIG. 3 is a diagram that shows an example of internal data of a condition retaining unit, according to some embodiments.

### DETAILED DESCRIPTION OF THE DISCLOSURE

The disclosure will now be described by reference to some embodiments. This does not intend to limit the scope of the present disclosure, but to exemplify the disclosure.

As described previously, in a future house, it is assumed that a person other than the residents or a movable body is allowed to enter the house so that a resident receives a service from an outside service provider or provides a service to an outside service receiver. However, there is no need to allow all the persons or movable bodies entering the house to use all the areas within the house freely. Therefore, it is necessary to manage an area in which staying or moving is permitted, with respect to each person or each movable body.

Accordingly, some embodiments of the present disclosure propose a space management system capable of determining whether or not each person or movable body entering a house is allowed to stay or move, and physically or psychologically restricting the stay or move based on the determination result. Introducing such a new security technology enables appropriate protection of safety and privacy of life, even when a third party or a movable body enters a house. Accordingly, a resident can safely invite a third party or a movable body into the house, so that the resident's convenience can be improved, and an enriched life can be realized.

Such a space management technology can be applied to arbitrary living spaces besides houses, including buildings or premises where persons live, lodge, or stay, such as accommodation facilities, premises including parking spaces or yards provided with houses or accommodation facilities, and facilities where babies and infants or elderly persons can stay. The present disclosure, in some embodiments, may describe a technology for managing a space within a house.

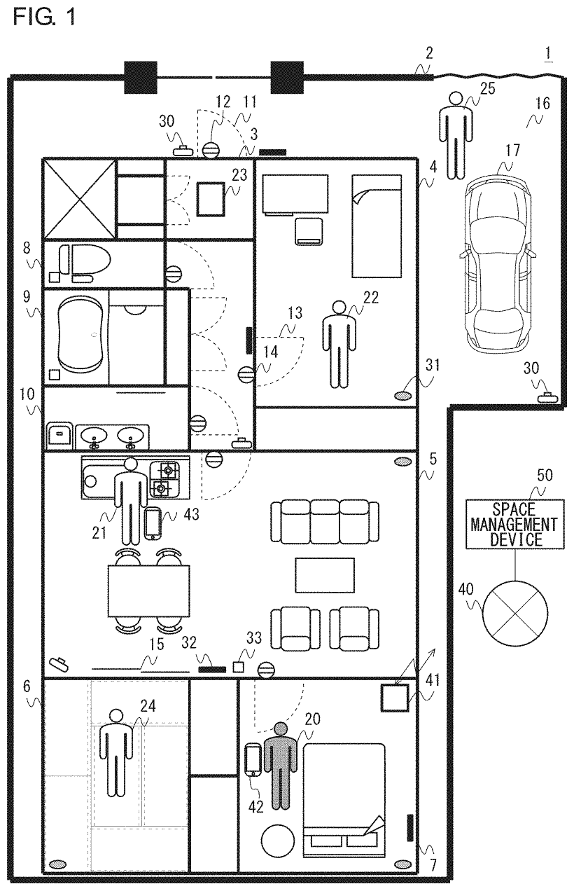

FIG. 1 shows a configuration of a space management system according to some embodiments. The space management system 1 includes a house 2, which is an example of a space to be managed, and a space management device 50 that manages staying or moving of a person or a movable body present in the house 2. The house 2 includes multiple indoor areas including an entrance 3, a Western-style room 4, a living room (LDK) 5, a Japanese-style room 6, a bed room 7, a toilet 8, a bathroom 9, and a washroom 10, and multiple outdoor areas including a parking space 16.

Besides visitors including the family, relatives, and acquaintances of a resident 20, others may enter the house 2, including: a service provider 21 who provides a service, such as housekeeping, caregiving, and delivery, to the resident 20; a service receiver 22 who enjoys a service, such as private lodging and parking space rental, from the resident 20; a movable body 23, such as a robot for performing cleaning or other work within the house 2, and an unmanned aircraft or an automated driving car for delivering goods to a resident; a renter 24 who pays a rent to the resident 20 to rent the Japanese-style room 6; and an owner 25 of a vehicle 17 who pays a rent for the parking space 16 to the resident 20 to park the vehicle 17 in the parking space 16. The space management device 50 retains conditions regarding permission to stay in each area, enter each area, pass through each area, and exit from each area, with respect to each person and each movable body that may enter the house 2.

In the house 2, an imaging device 30 and a human detection sensor 31 are installed as detection devices for detecting identification information and position information of a person or a movable body present in the house 2. The imaging device 30 captures an image of an area within the house 2. The space management device 50 analyzes the image captured by the imaging device 30 to detect the identification information and position information of a person or a movable body. The human detection sensor 31 detects a person coming closer to the human detection sensor 31. As a detection device, other arbitrary type of detection device may be installed in the house 2. For example, an authentication device for authenticating biological information, such as a fingerprint, a vein, and a face, may be installed, or, via communication with a mobile terminal device 43 carried by a person present within the house 2, identification information and position information of the person may be obtained. The image captured by the imaging device 30 and the information detected by the human detection sensor 31 is transmitted to a home server 41 via wireless communication. The home server 41 transmits the gathered information to the space management device 50 via the Internet 40.

A door 11 installed at the entrance 3 is provided with a lock 12 of which setting and releasing can be controlled by the space management device 50, so that entering and exiting from the house is managed by the space management device 50. Also, a door 13 at the entrance of each room within the house 2 is provided with a lock 14 of which setting and releasing can be controlled by the space management device 50, so that entering and exiting from each room is also managed by the space management device 50. Based on the identification information of a person or a movable body present in the house 2, the space management device 50 determines whether or not the person or movable body is allowed to enter or exit from the house or a room, and controls setting and releasing of the lock 12 or the lock 14 based on the determination result.

Since a sliding door 15 installed at the entrance of the Japanese-style room 6 is not provided with a lock, entering the Japanese-style room 6 cannot be physically restricted. However, a presentation device 32 and a speaker 33 are provided near the sliding door 15 to present information regarding permission to enter or exit from the room and to issue a warning to a person who is to enter the room contrary to the conditions. For example, based on the identification information of a person or a movable body present near the sliding door 15, the space management device 50 determines whether or not the person or movable body is allowed to enter the Japanese-style room 6, and presents the determination result using the presentation device 32 and the speaker 33.

Thus, the space management system 1 divides the inside of the house 2 into multiple areas and physically or psychologically restricts entering each area, for example, so as to manage the movable range of a person who enters the house. This can appropriately protect safety and privacy of the resident.

An area as a unit of management need not necessarily be separated as a physical section by walls or sliding doors, and an access level may be set to an area having arbitrary square measure and an arbitrary shape. For example, a restriction may be set such that nobody gets closer to an expensive work of art or such that nobody stays near a shelf containing valuables for a predetermined period of time or more. In this way, the space management system 1, in some embodiments, may construct a security layer with no steps within a space and can individually control the access levels for persons and movable bodies. Accordingly, spaces can be managed more appropriately, so that the safety and convenience of the resident can be improved, and the convenience of a person who enters the house can also be improved.

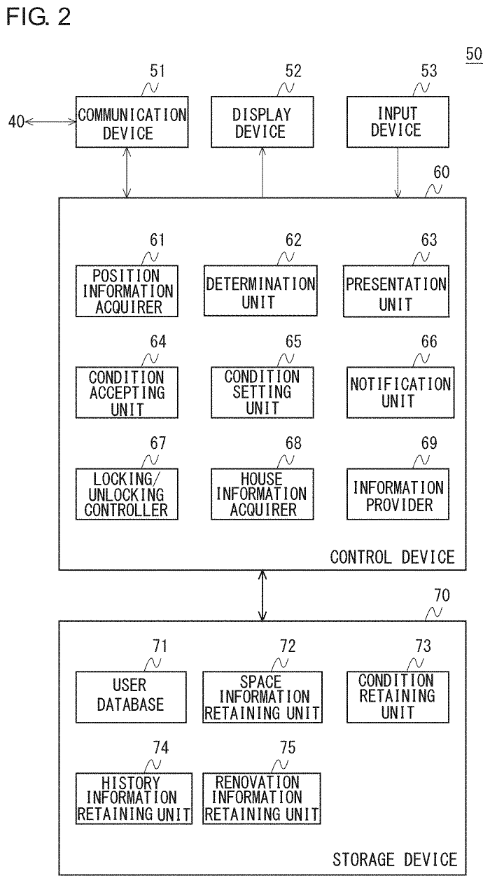

FIG. 2 shows a configuration of the space management device according to some embodiments. The space management device 50 includes a communication device 51, a display device 52, an input device 53, a control device 60, and a storage device 70. The space management device 50 may be a server device, a personal computer, or other device, or may be a mobile terminal, such as a cellular phone terminal, a smartphone, and a tablet terminal.

The communication device 51 controls communication with other devices via a communication network, such as the Internet 40. The communication device 51 may perform communication using an arbitrary wired or wireless communication scheme. The display device 52 displays a screen generated by the control device 60. The display device 52 may be a liquid crystal display device, an organic EL display device, or the like. The input device 53 transmits, to the control device 60, an instruction input from a user or a manager of the space management device 50. The input device 53 may be a mouse, a keyboard, a touch pad, or the like. The display device 52 and the input device 53 may be implemented as a touch panel.

The storage device 70 stores programs, data, and the like used by the control device 60. The storage device 70 may be semiconductor memory, a hard disk, or the like. The storage device 70 includes a user database 71, a space information retaining unit 72, a condition retaining unit 73, a history information retaining unit 74, and a renovation information retaining unit 75.

The user database 71 stores information on a user, such as the resident 20, who uses the space management device 50. The space information retaining unit 72 stores information regarding a user's house. For example, the space information retaining unit 72 stores data indicating the shapes of multiple divided areas in the house 2, such as the floor plan of the house 2, and information on the types and positions of furniture, equipment, the lock 14, the imaging device 30, the human detection sensor 31, the presentation device 32, and the speaker 33 installed in the house 2.

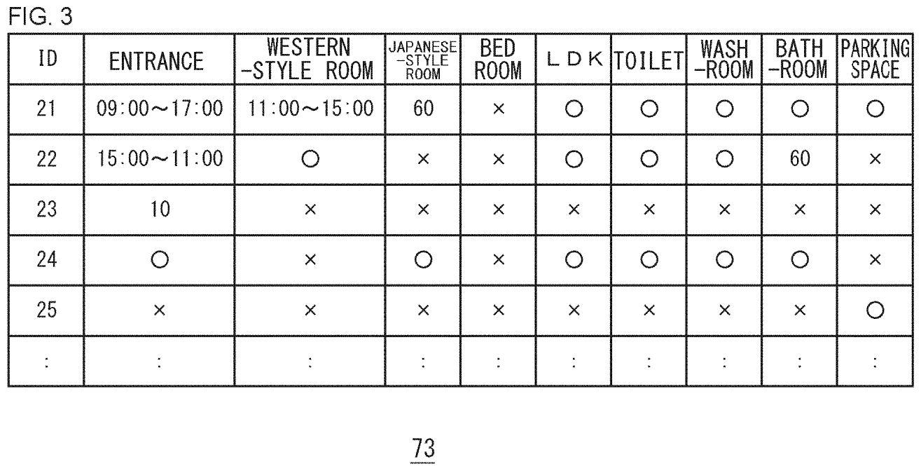

The condition retaining unit 73 stores a condition regarding a position of a person or a movable body in the house. FIG. 3 shows an example of internal data of the condition retaining unit 73. The condition retaining unit 73 retains conditions regarding staying in an area, entering the area, passing through the area, and exiting from the area, with respect to each person and each movable body, and also with respect to each area in the house 2.

For example, the service provider 21 as a housekeeping agent can enter the inside of the house 2 and the outdoors within the premises during business hours “from 9:00 to 17:00” and is allowed to enter and stay in the LDK 5, toilet 8, bathroom 9, washroom 10, and parking space 16 during the hours. Entering and staying in the Western-style room 4 is permitted during a time period from 11:00 to 15:00 for which no guest stays, and the service provider 21 cleans up the Western-style room 4 during the time period. Entering and staying in the Japanese-style room 6 is permitted only for 60 minutes, and the service provider 21 cleans up the Japanese-style room 6 during the time.

The service receiver 22 who lodges in the Western-style room 4 can enter the inside of the house 2 from 15:00 as the check-in time to 11:00 on the following day as the check-out time. During the time, the service receiver 22 is allowed to enter and stay in the Western-style room 4, LDK 5, toilet 8, and washroom 10 but is not allowed to enter the parking space 16. Entering and staying in the bathroom 9 is permitted only for 60 minutes, and the service receiver 22 takes a bath during the time.

The movable body 23 delivering goods can enter the inside of the house 2 at arbitrary time to deliver the goods in the entrance 3, but the permitted sojourn time is 10 minutes. Also, entering the Western-style room 4, LDK 5, Japanese-style room 6, bed room 7, toilet 8, bathroom 9, washroom 10, and parking space 16 is not permitted.

The renter 24 renting the Japanese-style room 6 can enter the inside of the house 2 at arbitrary time and can freely use the LDK 5, Japanese-style room 6, toilet 8, bathroom 9, and washroom 10. However, entering the Western-style room 4, bed room 7, and parking space 16 is not permitted.

The owner 25 of the vehicle 17 renting the parking space 16 can enter the parking space 16 during a time period for which the owner 25 rents the parking space 16 but is not allowed to enter the inside of the house 2. The parking space 16 may be used as a pay-by-the-hour parking lot in which a vehicle can be temporarily parked, or as monthly parking in which a renter, who has a lease agreement with the owner of the parking space 16 to lease the parking space 16 for a predetermined period, can park a vehicle. In the former case, the parking space 16 may be rented out to the service provider 21 or the service receiver 22, or to other third party. In the latter case, the parking space 16 may be rented out to the renter 24 of the Japanese-style room 6, or to other third party.

The history information retaining unit 74 stores histories of information acquired by a position information acquirer 61, determination results from a determination unit 62, information presented by a presentation unit 63, conditions accepted by a condition accepting unit 64, information conveyed by a notification unit 66, and control information from a locking/unlocking controller 67. The renovation information retaining unit 75 stores information regarding house renovation. For example, the renovation information retaining unit 75 stores information including product numbers of equipment and building components currently installed or used in the house, information on equipment and building components available for renovation or replacement of the currently-used equipment and building components, and house history information indicating histories of renovation.

The control device 60 includes the position information acquirer 61, the determination unit 62, the presentation unit 63, the condition accepting unit 64, a condition setting unit 65, the notification unit 66, the locking/unlocking controller 67, a house information acquirer 68, and an information provider 69. Each of these configurations may be implemented by a CPU or memory of any given computer, an LSI, or the like in terms of hardware, and by a memory-loaded program or the like in terms of software. In some embodiments are shown functional block configurations realized by cooperation thereof. Therefore, it would be understood by those skilled in the art that these functional blocks may be implemented in a variety of forms by hardware only or a combination of hardware and software.

From a detection device for detecting identification information and position information of a person or a movable body present in the house 2, the position information acquirer 61 acquires the identification information and position information. The position information acquirer 61 may acquire the identification information and position information from the home server 41, or directly from each detection device installed in the house 2.

Based on the identification information and position information acquired by the position information acquirer 61, the determination unit 62 refers to the conditions retained in the condition retaining unit 73 to determine whether or not a person or a movable body present in the house 2 is allowed to stay at the position or move to another position. The determination unit 62 may determine whether or not a person or a movable body identified by the identification information acquired by the position information acquirer 61 is allowed to stay in each area, enter each area, pass through each area, and exit from each area.

When the determination unit 62 judges that the stay or move is not permitted, the presentation unit 63 presents the result such that the said person can recognize the presentation. The presentation unit 63 may present information regarding whether or not the stay or move is permitted, by means of the presentation device 32 or the speaker 33 installed in the house 2. Also, the presentation unit 63 may present information by means of the presentation device 32 or the speaker 33 provided near the target person of the presentation. This can alert a person who is to impermissibly stay or move by reason of ignorance, negligence, or a deliberate intention, thereby psychologically restricting such a stay or move.

The condition accepting unit 64 accepts, from the manager of the house 2, conditions regarding staying in each area, entering each area, passing through each area, and exiting from each area, and stores the conditions in the condition retaining unit 73. The condition accepting unit 64 may accept conditions from a mobile terminal device 42 of the resident 20.

The condition setting unit 65 sets conditions regarding staying in each area, entering each area, passing through each area, and exiting from each area, and stores the conditions in the condition retaining unit 73. When a stop condition or a removal condition regarding the time, day of week, weather, or the like is added to a condition retained in the condition retaining unit 73, the condition setting unit 65 determines whether or not the stop condition or removal condition is satisfied, and, when it is satisfied, the condition setting unit 65 validates or invalidates, or changes the condition stored in the condition retaining unit 73. For example, when there is no reservation for the private lodging and the service receiver 22 is not lodging in the Western-style room 4, the relevant condition may be changed such that the service provider 21 can enter and stay in the Western-style room 4 at any time during the business hours. The condition setting unit 65 may automatically validate or invalidate, or change a condition according to a predetermined stop condition or removal condition, or may validate or invalidate, or change a condition according to an instruction received from the manager of the house 2.

When staying in an area, entering an area, passing through an area, or exiting from an area contrary to the conditions retained in the condition retaining unit 73 is detected, the notification unit 66 issues a warning to the violator by means of the presentation device 32 or the speaker 33, or transmits a notification of the fact to the mobile terminal device 42 of the resident 20 as the manager of the area. Accordingly, an appropriate action can be given to a person who has impermissibly stayed or moved by reason of ignorance, negligence, or a deliberate intention, so that further violations can be restrained. Also, by preparing a system for appropriate actions, violations can be prevented from occurring.

The locking/unlocking controller 67 controls the setting and releasing of the lock of a door at the entrance of each area. When entering an area, passing through an area, or exiting from an area is permitted by the determination unit 62, the locking/unlocking controller 67 releases the lock of a corresponding door, and, when it is not permitted, the locking/unlocking controller 67 sets the lock of the door.

The house information acquirer 68 acquires information regarding problems in building components or equipment of the house 2, from the mobile terminal device 43 of the service provider 21 who has entered the house 2 or the mobile terminal device of the service receiver 22 who has entered the house 2. Accordingly, a problem in the building components or equipment of the house 2 can be promptly found and appropriately handled, so that the convenience of the resident 20 can be improved.

Based on the information acquired by the house information acquirer 68, the information provider 69 retrieves information regarding renovation of the house 2 from the renovation information retaining unit 75 and provides the information thus retrieved to the mobile terminal device 42 of the resident 20 of the house 2. Accordingly, the service provider 21 can propose appropriate renovation to the resident 20 utilizing the opportunities to enter the house 2, improving the convenience of the resident 20.

Although some embodiments describe an example in which the space management device 50 is provided for overall management of multiple houses, the space management device 50 may be provided for each house. In this case, the home server 41 may have the functions of the space management device 50, for example. Also, the functions may be allocated to the home server 41 and the space management device 50. For example, the home server 41 may manage information that should not be disclosed, such as personal information of a resident or manager of the house 2, and the space management device 50 may manage information input from or output to the service provider 21 or the service receiver 22. This can also improve the security of information. In another example, the home server 41 need not be provided. In this case, the devices including the imaging device 30, human detection sensor 31, presentation device 32, and speaker 33 communicate directly with the space management device 50.

When the disclosure embodied by the embodiment and modifications set forth above are generalized, the following technical ideas may be derived.

To solve the problem above, a space management device according to one aspect of the present disclosure includes; a space information retaining unit that retains information regarding a living space including a building or premises where a person lives, lodges, or stays; a condition retaining unit that retains a condition regarding a position of a person or a movable body in the living space; a position information acquirer that acquires, from a detection device for detecting identification information and position information of a person or a movable body present in the living space, the identification information and position information; and a determination unit that refers to a condition retained in the condition retaining unit to determine whether or not a person or a movable body present in the living space is allowed to stay at the position or move to another position, based on the identification information and position information acquired by the position information acquirer. The space information retaining unit retains information regarding multiple divided areas in the living space. The condition retaining unit retains a condition regarding staying in the area, entering the area, passing through the area, and exiting from the area, with respect to each area. The determination unit determines whether or not a person or a movable body identified by identification information acquired by the position information acquirer is allowed to stay in the area, enter the area, pass through the area, and exit from the area. According to this aspect, whether or not a person or a movable body present in a living space is allowed to stay or move can be automatically determined and appropriately managed.

The condition retaining unit may retain a condition regarding a service provider who provides, in the living space, a service to a person living, lodging, or staying in the living space. According to this aspect, even when a person for delivery, caregiving, cleaning, housekeeping, or the like is allowed to enter the house while the resident is not at home, whether or not such a service provider is allowed to stay or move can be automatically controlled, and the living space can be appropriately managed.

The condition retaining unit may retain a condition regarding a service receiver who enjoys, in the living space, a service from a person living, lodging, or staying in the living space. According to this aspect, in the case where a resident provides a service, such as renting out the house, a room, a parking lot, equipment, or the like, even when a service receiver is allowed to enter the house while the resident is not at home, whether or not the service receiver is allowed to stay or move can be automatically controlled, and the living space can be appropriately managed.

The space management device may further include a living space information acquirer that acquires information regarding a problem in building components or equipment in the living space, from the service provider or the service receiver. According to this aspect, a problem in the building components or equipment in the living space can be promptly recognized and appropriate countermeasures can be taken, so that the convenience of the resident can be improved.

The space management device may further include an information provider that provides information regarding renovation of the living space to a manager of the living space, based on information acquired by the living space information acquirer. According to this aspect, a problem in the building components or equipment in the living space can be promptly recognized and information regarding renovation can be provided to the manager, so that the convenience of the manager can be improved.

The space management device may further include a condition accepting unit that accepts a condition regarding the area from a manager of the area and stores the condition in the condition retaining unit. According to this aspect, the manager can arbitrarily set a desired condition and can manage whether or not a person or a movable body present in a living space is allowed to stay or move.

The space management device may further include a presentation unit that presents, when the determination unit has judged that the stay or move is not permitted, the result such that the said person or movable body recognizes the presentation. According to this aspect, a person who is to impermissibly stay or move by reason of ignorance, negligence, or a deliberate intention can be alerted, so that such a stay or move can be psychologically restricted.

The space management device may further include a notification unit that issues, when staying in the area, entering the area, passing through the area, or exiting from the area contrary to the condition is detected, a warning to the violator or notifies a manager of the area of the fact. According to this aspect, an appropriate action can be given to a person who has impermissibly stayed or moved by reason of ignorance, negligence, or a deliberate intention, so that further violations can be restrained.

The space management device may further include a locking/unlocking controller that controls locking and unlocking of an opening/closing unit provided at an entrance of the area. When the determination unit has permitted entering the area, passing through the area, or exiting from the area, the locking/unlocking controller may unlock the opening/closing unit. According to this aspect, impermissible entering, passing through, or exiting can be physically restricted.

What is claimed is:

1. A space management device, comprising:
a space information retaining unit that retains information regarding a living space including a building or premises where a person lives, lodges, or stays;
a condition retaining unit that retains a condition regarding a position of a person or a movable body in the living space;
a position information acquirer that acquires, from a detection device for detecting identification information and position information of a person or a movable body present in the living space, the identification information and position information; and
a determination unit that refers to a condition retained in the condition retaining unit to determine whether or not a person or a movable body present in the living space is allowed to stay at the position or move to another position, based on the identification information and position information acquired by the position information acquirer, wherein
the space information retaining unit retains information regarding a plurality of divided areas in the living space,
the condition retaining unit retains a condition regarding staying in the area, entering the area, passing through the area, and exiting from the area, with respect to each area, and
the determination unit determines whether or not a person or a movable body identified by identification information acquired by the position information acquirer is allowed to stay in the area, enter the area, pass through the area, and exit from the area.

2. The space management device of claim 1, wherein the condition retaining unit retains a condition regarding a service provider who provides, in the living space, a service to a person living, lodging, or staying in the living space.

3. The space management device of claim 1, wherein the condition retaining unit retains a condition regarding a service receiver who enjoys, in the living space, a service from a person living, lodging, or staying in the living space.

4. The space management device of claim 2, further comprising a living space information acquirer that acquires information regarding a problem in building components or equipment in the living space, from the service provider or the service receiver.

5. The space management device of claim 4, further comprising an information provider that provides information regarding renovation of the living space to a manager of the living space, based on information acquired by the living space information acquirer.

6. The space management device of claim 1, further comprising a condition accepting unit that accepts a condition regarding the area from a manager of the area and stores the condition in the condition retaining unit.

7. The space management device of claim 1, further comprising a presentation unit that presents, when the determination unit has judged that the stay or move is not permitted, the result such that the said person or movable body recognizes the presentation.

8. The space management device of to claim 1, further comprising a notification unit that issues, when staying in the area, entering the area, passing through the area, or exiting from the area contrary to the condition is detected, a warning to the violator or notifies a manager of the area of the fact.

9. The space management device of claim 1, further comprising a locking/unlocking controller that controls locking and unlocking of an opening/closing unit provided at an entrance of the area, wherein,
when the determination unit has permitted entering the area, passing through the area, or exiting from the area, the locking/unlocking controller unlocks the opening/closing unit.

10. A space management method, comprising:
acquiring, from a detection device for detecting identification information and position information of a person or a movable body present in a living space including a building or premises where a person lives, lodges, or stays, the identification information and position information; and
referring to information regarding a plurality of divided areas in the living space retained in a space information retaining unit, which retains information regarding the living space, and also referring to a condition regarding staying in the area, entering the area, passing through the area, and exiting from the area retained in a condition retaining unit, which retains a condition regarding a position of a person or a movable body in the living space, to determine, based on the identification information and position information acquired, whether or not a person or a movable body present in the living space identified by the identification information acquired is allowed to stay in the area, enter the area, pass through the area, or exit from the area.

11. The space management device of claim 2, wherein the condition retaining unit retains a condition regarding a service receiver who enjoys, in the living space, a service from a person living, lodging, or staying in the living space.

12. The space management device of claim 3, further comprising a living space information acquirer that acquires information regarding a problem in building components or equipment in the living space, from the service provider or the service receiver.

13. The space management device of claim 2, further comprising a condition accepting unit that accepts a condition regarding the area from a manager of the area and stores the condition in the condition retaining unit.

14. The space management device of claim 3, further comprising a condition accepting unit that accepts a condition regarding the area from a manager of the area and stores the condition in the condition retaining unit.

15. The space management device of claim 4, further comprising a condition accepting unit that accepts a condition regarding the area from a manager of the area and stores the condition in the condition retaining unit.

16. The space management device of claim 5, further comprising a condition accepting unit that accepts a condition regarding the area from a manager of the area and stores the condition in the condition retaining unit.

17. The space management device of claim 2, further comprising a presentation unit that presents, when the determination unit has judged that the stay or move is not permitted, the result such that the said person or movable body recognizes the presentation.

18. The space management device of claim 3, further comprising a presentation unit that presents, when the determination unit has judged that the stay or move is not permitted, the result such that the said person or movable body recognizes the presentation.

19. The space management device of claim 4, further comprising a presentation unit that presents, when the determination unit has judged that the stay or move is not permitted, the result such that the said person or movable body recognizes the presentation.

20. The space management device of claim 5, further comprising a presentation unit that presents, when the determination unit has judged that the stay or move is not permitted, the result such that the said person or movable body recognizes the presentation.
